(19) United States
(12) Patent Application Publication
(10) Pub. No.: US 2007/0212290 A1
(43) Pub. Date: Sep. 13, 2007

(54) Preparation of pile of carbon nanotubes and fiber therefrom

(75) Inventors: Lianxi Zheng, Los Alamos, NM (US); Yuntian T. Zhu, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/438,794

(22) Filed: May 22, 2006

Related U.S. Application Data
(60) Provisional application No. 60/735,032, filed on Nov. 8, 2005.

(51) Int. Cl. C01B 31/02; D01F 9/127

(52) U.S. Cl. 423/445 B

(57) ABSTRACT

A pile of carbon nanotubes was prepared by placing a small amount of catalyst solution on a substrate, putting the substrate into a furnace, purging the furnace, and heating the substrate under a flow of gaseous carbon source. A pile of carbon nanotubes formed on the substrate. Nanotubes from the pile were spun into a fiber.

### RELATED APPLICATIONS

This application claims the benefit of U.S. Provisional Patent Application Ser. No. 60/735,032 filed Nov. 8, 2005, which is incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to the preparation of carbon nanotubes and more particularly to the preparation of a pile of carbon nanotubes, and to fibers spun from the pile.

### BACKGROUND OF THE INVENTION

Carbon nanotubes (CNTs) are seamless nanometer scale diameter tubes of graphite sheets. They have shown promise for nanoscale electronic devices, chemical sensors, high strength materials, field emission arrays, tips for scanning probe microscopy, gas storage, and other important applications.

CNTs may be multi-walled or single-walled. Multi-walled CNTs were discovered in the hard deposit formed on the graphite cathode of an arc-evaporation apparatus used to prepare carbon fullerenes C₆₀ and C₇₀. Single-walled CNTs were reported shortly thereafter.

Single walled CNTs have been prepared using arc and laser techniques. There has been some success in producing single-walled CNTs from the catalytic cracking of hydrocarbons. Single-walled CNTs have also been produced from the catalytic disproportionation of carbon monoxide (CO). In an example, the diameters of single walled carbon nanotubes (SWNT) were found to vary from 1 nm to 5 nm, and seemed vary as a function of the size of particle size of the metal catalyst.

Rope-like bundles of single-walled CNTs have been generated from the thermal cracking of benzene using an iron catalyst and sulfur additive at temperatures between 1100-1200 degrees Celsius. These single-walled CNTs were roughly aligned in bundles and woven together, similar to those obtained using an electric arc or laser vaporization.

### SUMMARY OF THE INVENTION

In accordance with the purposes of the present invention, as embodied and broadly described herein, the present invention includes a method for preparing a pile of carbon nanotubes. The method involves heating a catalyst species on a substrate in an atmosphere comprising a gaseous source of carbon at a temperature sufficient to decompose the gaseous source of carbon and form a pile of carbon nanotubes.

The invention also includes a pile of carbon nanotubes prepared by heating a catalyst species on a substrate in an atmosphere comprising a gaseous source of carbon at a temperature sufficient to decompose the gaseous source of carbon.

The invention also includes a method for preparing a fiber comprising forming a pile of carbon nanotubes by a method comprising heating a catalyst species on a substrate in an atmosphere comprising a gaseous source of carbon at a temperature sufficient to decompose the gaseous source of carbon and form a pile of carbon nanotubes, and thereafter spinning a fiber from the pile of carbon nanotubes.

The invention also includes a fiber prepared by heating a catalyst species on a substrate in an atmosphere comprising a gaseous carbon source at a temperature sufficient to decompose the gaseous carbon source and form a pile of carbon nanotubes, and thereafter spinning a fiber from the pile of carbon nanotubes.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows a schematic representation of an embodiment apparatus used for preparing a pile of carbon nanotubes.

FIG. 2 shows an optical image of a pile of nanotubes on a substrate prepared using the apparatus of FIG. 1.

FIG. 3 shows a side view of the pile of nanotubes of FIG. 2.

FIG. 4 shows a transmission electron microscope (TEM) image of a carbon nanotube from the pile of FIG. 2.

FIG. 5 shows an image of a carbon nanotube fiber that was spun from the pile of carbon nanotubes of FIG. 2.

### DETAILED DESCRIPTION

The invention relates to the preparation of a pile of carbon nanotubes and to fibers spun from the pile. Individual nanotubes from the pile are believed to have lengths of about 2 millimeters, about 3 millimeters, about 4 millimeters, and longer.

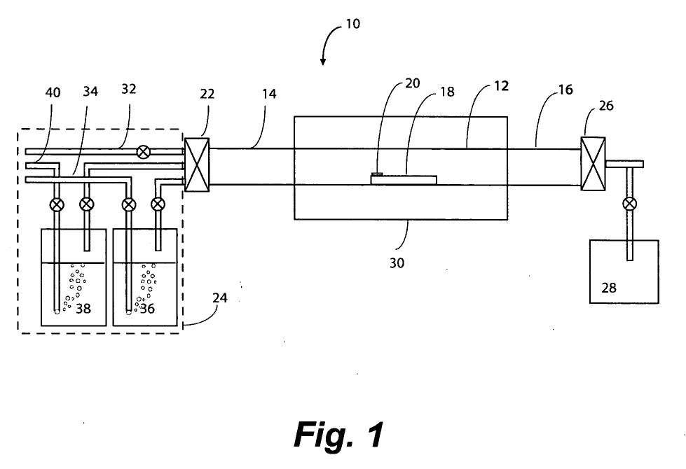

The practice of the invention can be further understood with the accompanying figures. Similar or identical structure is identified using identical callouts. FIG. 1 shows a schematic representation of an embodiment apparatus embodiment used for preparing a pile of carbon nanotubes. Apparatus 10 includes quartz tube 12 having inlet end 14 and outlet end 16. Catalyst solution 20 is placed on the surface near an end of substrate 18, and then substrate 18 is placed inside tube 12 such that the end of substrate 18 with the catalyst solution is near inlet end 14.

Substrates that may be used with the present invention include silicon; silicon having a top layer of silicon dioxide; silicon carbide; silicon carbide with a top layer of silicon dioxide; silicon nitride; silicon nitride with a top layer of silicon dioxide; quartz; and glass. In an embodiment, substrate 18 is a silicon (100) substrate with dimensions of about 5 millimeters in width and about 10 millimeters in length.

Transition metal catalyst species are preferred. In an embodiment, solution 20 is a solution of ferric chloride (FeCl₃) catalyst (0.10 molar) and cobalt (III) chloride catalyst (0.1 molar) in ethanol solvent, and substrate 18 is a silicon substrate. It should be understood, however, that these materials are only exemplary and that other catalysts (nickel containing catalysts, for example) and catalyst/substrate combinations could also be used.

The purpose of the solvent is to dissolve the catalyst and thereafter provide finely divided metal catalyst on the substrate after evaporation of the solvent. While an alcohol solution of FeCl₃ and CoCl₃ was used in a demonstration example, it should be understood any solvent capable of dissolving the transition metal containing species could also be used.

Inlet end 14 of quartz tube 12 is connected via connector 22 to inlet gas manifold 24, which is capable of sending gas through into tube 12. Tube 12 includes outlet end 16, which is connected via connector 26 to an outlet assembly that includes vacuum pump 28. With substrate 18 inside tube 12, inlet end 14 is connected to manifold 24, and tube 12 is placed inside furnace 30. Furnace 30 is then powered up, heating quartz tube 12 and substrate 18, and causing evaporation of solvent from solution 20.

In an embodiment, a flowing gas mixture (about 10.5 cc/min) of argon and hydrogen (about 94 percent argon, about 6 percent hydrogen) was sent through end 32 of manifold 24, into inlet end 14, and into tube 12 while furnace 30 heated substrate inside to a temperature of about 900 degrees Celsius. After about 30 minutes, ethanol and acetone vapors were added to the hydrogen/argon gas mixture by sending hydrogen/argon gas through ends 34 and 40 of inlet gas manifold 24. The hydrogen/argon gas bubbled through ethanol solution 36 at a flow rate of about 4 cc/min, and through acetone solution 38 at a flow rate of 8.5 cc/min. After about one hour more, the power to furnace 30 is turned off to allow quartz tube 12 to cool down. The substrate was removed from the tube. A pile of carbon nanotubes formed on the substrate.

The flow rate of the argon/hydrogen gas mixture may be in the range of from about 1 cc/min to about 50 cc/min.

The flow rate of the gas bubbled through the ethanol may be in the range of from about 1 cc/min to about 50 cc/min.

The flow rate of the gas bubbled through the acetone may be in the range of from about 1 cc/min to about 50 cc/min.

In an embodiment, the carbon source for preparing a pile of carbon nanotubes was a mixture of alcohol and acetone vapors. Other input gases that can be used with alcohol acetone vapors include hydrogen (H₂), inert gases (argon, helium, and nitrogen and mixtures thereof, for example), and mixtures of hydrogen and inert gas. These other input gases are used during the initial heating stages to provide an inert and/or reducing atmosphere, so that the solution of transition metal catalyst species would release finely divided metal catalyst particles after the solvent is evaporated from the catalyst solution. Hydrogen may also be used to provide this reducing atmosphere. However, it has been determined that the use of hydrogen is not critical because inert gases such as argon can be used instead.

In an embodiment, the temperature used for decomposing the alcohol and acetone was about 900 degrees Celsius. It is expected that carbon nanotubes can be formed according to the invention when the substrate is heated to a temperature of from about 600 degrees Celsius to about 1200 degrees Celsius.

Because of the length of the CNTs in the pile that are capable of being produced, the invention is expected to have a significant impact for applications in which shorter carbon nanotubes are inadequate. It is expected that the relatively long carbon nanotubes produced according to the present invention can be used to make fibers that are much stronger than any current engineering fibers, and that the carbon nanotubes and fibers could be used for applications that include, but are not limited to, neuronal growth, micro electric motors, neuronal implants, biological and chemical sensors, optical and electronic cables, and micro electromechanical systems.

The following EXAMPLES illustrate embodiments of the invention.

### EXAMPLE 1

### Catalyst Preparation

A catalyst solution was prepared by dissolving enough ferric chloride (FeCl₃) and cobalt (III) chloride (CoCl₃) in ethanol to produce a solution that was 0.1 molar in cobalt and 0.1 molar in iron.

### EXAMPLE 2

### Preparation of Pile of Carbon Nanotubes

The catalyst solution of EXAMPLE 1 was applied with a pen to a short edge of a silicon (100) substrate having dimensions of about 5 mm×10 mm and a 0.1-micrometer thick surface layer of SiO2. The substrate was supported on a quartz plate having dimensions of about 15 mm×50 mm. The substrate and quartz plate were then placed into a 1-inch diameter quartz tube. The tube was placed in a tube furnace. The furnace was purged for about 0.5 hour with about 20 sccm of forming gas (Ar+6% H₂). As the furnace was being purged, it was heated at a rate of 60° C./min to a temperature of about 900° C. When the furnace reached this temperature, the forming gas was reduced to 10.5 sccm and a gaseous carbon source was added to the gaseous stream by bubbling 4 sccm of forming gas through ethanol, and bubbling 8.5 sccm of forming gas through acetone, and adding these to the stream that was already flowing through the quartz tube. The furnace temperature was maintained for about one hour, and the furnace was cooled down. After the furnace cooled down, the substrate was removed. A pile of carbon nanotubes formed on the substrate.

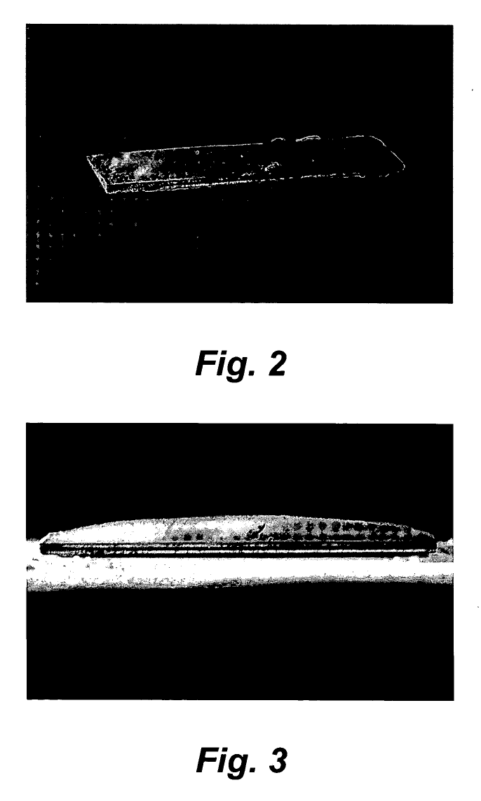

An optical image of the pile is shown in FIG. 2. A side view image of the pile is shown in FIG. 3.

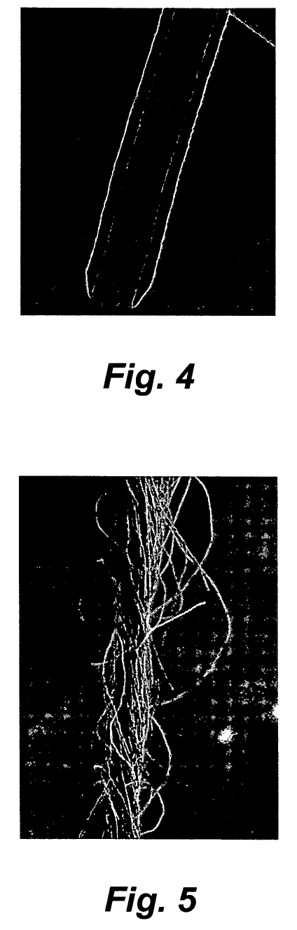

A transmission electron spectroscopy (TEM) image of the end of one of the nanotubes from the pile is shown in FIG. 4. The diameter of this nanotube is about 100 nanometers.

### EXAMPLE 3

### Preparation of a Fiber from the Pile of Carbon Nanotubes

A multi-CNT fiber of carbon nanotubes was spun from the pile of carbon nanotubes of EXAMPLE 2. A needle was used to pick up nanotubes from the pile. A fiber of nanotubes formed as the needle was rotated and pulled away from the pile. The fiber had a length greater than 5 centimeters.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for preparing a pile of carbon nanotubes comprising heating a catalyst species on a substrate in an atmosphere comprising a gaseous carbon source at a temperature sufficient to decompose the gaseous carbon source and form a pile of carbon nanotubes.

2. The method of claim 1, wherein the gaseous carbon source comprises alcohol and acetone.

3. The method of claim 1, wherein the atmosphere further comprises at least one gas selected from the group consisting of hydrogen, helium, argon, and nitrogen.

4. The method of claim 1, wherein the catalyst species comprises at least one transition metal.

5. The method of claim 1, wherein the catalyst species comprises iron and cobalt.

6. The method of claim 1, wherein the substrate comprises a material selected from the group consisting of silicon, silicon dioxide, silicon carbide, silicon nitride, quartz, and glass.

7. The method of claim 1, wherein the alcohol comprises ethanol.

8. The method of claim 1, wherein the catalyst species is heated to a temperature of from about 600 degrees Celsius to about 1200 degrees Celsius.

9. The method of claim 1, wherein the catalyst species is heated to a temperature of about 900 degrees Celsius.

10. A pile of carbon nanotubes prepared by heating a catalyst species on a substrate in an atmosphere comprising a gaseous carbon source at a temperature sufficient to decompose the gaseous carbon source and the acetone.

11. The pile of carbon nanotubes of claim 10, wherein the gaseous carbon source comprises alcohol and acetone.

12. The pile of carbon nanotubes of claim 10, wherein the catalyst species comprises at least one metal selected from the group consisting of iron, nickel, and cobalt.

13. The pile of carbon nanotubes of claim 10, wherein the atmosphere further comprises at least one gas selected from the group consisting of hydrogen, helium, argon, and nitrogen.

14. The pile of carbon nanotubes of claim 10, wherein the substrate comprises a material selected from the group consisting of silicon, silicon dioxide, silicon carbide, silicon nitride, quartz, and glass.

15. The pile of carbon nanotubes of claim 10, wherein the alcohol comprises ethanol.

16. The pile of carbon nanotubes of claim 10, wherein at least some of the carbon nanotubes of the pile comprise a length of at least 2 millimeters.

17. The pile of carbon nanotubes of claim 10, wherein the transition metal catalyst species is heated to a temperature of from about 600 degrees Celsius to about 1200 degrees Celsius.

18. The pile of carbon nanotubes of claim 9, wherein the catalyst species is heated to a temperature of about 900 degrees Celsius.

19. A method for preparing a fiber comprising heating a catalyst species on a substrate in an atmosphere comprising a gaseous carbon source at a temperature sufficient to decompose the gaseous carbon source and form a pile of carbon nanotubes, and thereafter spinning a fiber of carbon nanotubes from the pile of carbon nanotubes.

20. The method of claim 19, wherein the gaseous carbon source comprises alcohol and acetone.

21. The method of claim 19, wherein the atmosphere further comprises at least one gas selected from the group consisting of hydrogen, helium, argon, and nitrogen.

22. A fiber prepared by a method comprising heating a catalyst species on a substrate in an atmosphere comprising a gaseous carbon source at a temperature sufficient to decompose the gaseous carbon source and form a pile of carbon nanotubes therefrom, and thereafter spinning a fiber of carbon nanotubes from the pile of carbon nanotubes.

23. The method of claim 22, wherein the atmosphere further comprises at least one gas selected from the group consisting of hydrogen, helium, argon, and nitrogen.

24. The method of claim 22, wherein the alcohol comprises ethanol.
